(19) United States
(12) Patent Application Publication
(10) Pub. No.: US 2018/0087556 A1
(43) Pub. Date: Mar. 29, 2018

(54) Disassembleable nut

(71) Applicants: Ernest M. Hanners, West Frankfort, IL (US); Judy A. Hanners, West Frankfort, IL (US)

(72) Inventors: Ernest M. Hanners, West Frankfort, IL (US); Judy A. Hanners, West Frankfort, IL (US)

(21) Appl. No.: 15/330,479

(22) Filed: Sep. 26, 2016

(51) Int. Cl. F16B 37/08

(52) U.S. Cl. CPC F16B 37/0892

(57) ABSTRACT

Disclosed is a disassembleable nut comprised of two half-nuts held together by two bolts. The nut can be disassembled and reassembled at any points along the length of a bolt onto which the nut is screwed.

### BACKGROUND OF THE INVENTION

The invention described herein fits into the general category of machine tools. More particularly, the present invention is a nut, and specifically, this invention is a nut that can be disassembled.

It often happens that a nut being screwed onto a bolt faces an obstruction in that a portion of the bolt thread is destroyed or incorrectly aligned, and as a result, the nut becomes jammed into immobility at that position in being threaded onto the bolt. In such a situation the nut cannot be used as intended to be further threaded along the bolt to its desired position. The nut must then be unscrewed from the bolt and no other nut can be properly used on the bolt until the thread of the bolt is repaired.

It would be convenient if a nut could be used on a bolt even when part of the bolt's thread is impaired, but normally a nut cannot be used on such a bolt because a normal nut has to be screwed onto a bolt from the end of the bolt and cannot get past the impaired thread of the bolt to the nut's proper position on the bolt.

### BRIEF SUMMARY OF THE INVENTION

The present invention solves the above problems by being a nut that can be disassembled at any position on a bolt and that can be reassembled at any other position on the bolt.

The nut is comprised of two half-nuts which are held together by two smaller threaded bolts which hold the two half-nuts together to make the whole nut.

### BRIEF DESCRIPTION OF THE DRAWINGS

In the accompanying drawings, the nut is depicted as transparent to reveal interior detail even though in reality the nut is made of opaque steel.

FIG. 1 shows a top view of the assembled nut.

FIG. 2 shows a top view of the disassembled nut.

FIG. 3 shows a front edge view of the assembled nut.

FIG. 4 shows a front edge view of the disassembled nut.

FIG. 5 shows the inside surfaces of the disassembled nut, wherein the left half-nut of FIG. 4 has been rotated 90 degrees in a clockwise fashion, and wherein the right half-nut of FIG. 4 has been rotated 90 degrees in an anticlockwise fashion.

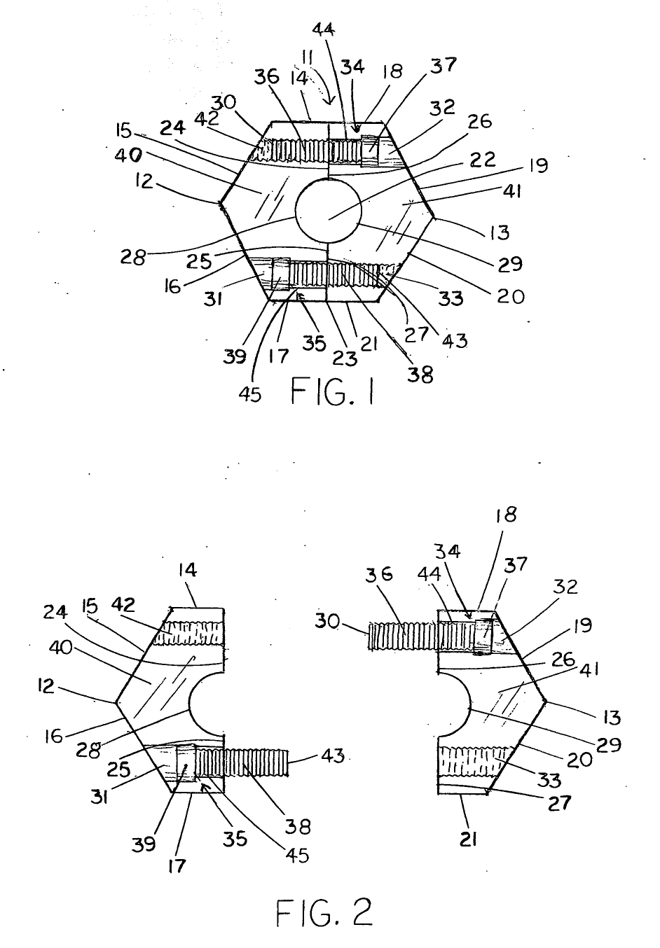

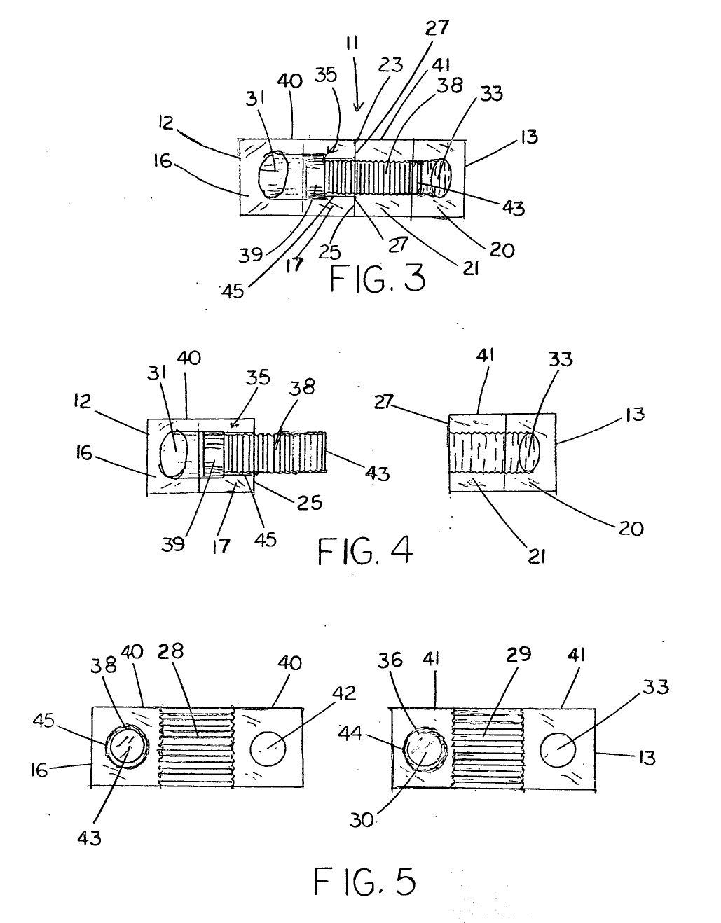

### DETAILED DESCRIPTION OF THE INVENTION

Looking at all of the figures together, it is seen that the disassembled nut 11 is comprised of two half-nuts 12 and 13, which are held together by screw bolts 34 and 35. The nut 11 has a top surface comprised of the two half-surfaces 40 and 41 and a bottom surface not shown. The nut 11 is hexagonal in shape and bordered by flat edge surfaces 15, 16, 19, and 20, and by the edge half-surfaces 14, 18, 17, and 21. The half-nuts 12 and 13 have flat interior surfaces 24 and 26, and 25 and 27, respectively, which meet at the junction 23.

The bolts 34 and 35 are comprised of the circular bolt heads 37 and 39, and the bolt bodies 30 and 43. The bolt bodies have screw threads 36 and 38. The bolt heads 37 and 39 have hex wrench depressions (not shown) but could alternatively have regular screw driver depressions or Philips screw driver depressions.

The half-nuts have smooth-sided holes 32 and 31 through which the bolt heads 37 and 39 fit, and slimmer smooth-sided holes 44 and 45 through which the bolt bodies 30 and 43 fit, and yet slimmer threaded holes 42 and 33 into which the threaded bolt bodies 30 and 43 are screwed.

Extending through the center of the nut is a central large hole 22 bounded by the threaded semicircular surfaces 28 and 29. It is the central large hole 22 through which the nut is intended to be screwed onto or clamped onto a large threaded bolt to which the nut is applied.

It should be noted that although a hexagonal nut is described in detail in this invention, a square nut could also have been utilized instead of a hexagonal nut in the same manner in which the hexagonal nut has been described.

What is claimed is:

1. A disassembleable nut comprised of two half-nuts held together by two or more bolts.

2. A disassembleable nut comprised of two half-nuts held together by two or more threaded bolts.

3. A disassembleable nut as described in claim 2 wherein the threaded bolts have hex wrench heads.

4. A disassembleable nut as described in claim 2 wherein the threaded bolts have regular screw driver heads.

5. A disassembleable nut as described in claim 2 wherein the threaded bolts have Philips screw driver heads.

6. A disassembleable nut as described in claim 1 wherein the nut is hexagonal.

7. A disassembleable nut as described in claim 2 wherein the nut is hexagonal.

8. A disassembleable nut as described in claim 3 wherein the nut is hexagonal.

9. A disassembleable nut as described in claim 4 wherein the nut is hexagonal.

10. A disassembleable nut as described in claim 5 wherein the nut is hexagonal.

11. A disassembleable nut as described in claim 1 wherein the nut is square.

12. A disassembleable nut as described in claim 2 wherein the nut is square.

13. A disassembleable nut as described in claim 3 wherein the nut is square.

14. A disassembleable nut as described in claim 4 wherein the nut is square.

15. A disassembleable nut as described in claim 5 wherein the nut is square.
